(19) United States
(12) Patent Application Publication
(10) Pub. No.: US 2015/0004338 A1
(43) Pub. Date: Jan. 1, 2015

(54) Packaging structure of container

(71) Applicant: Wun-Da Yang, Tainan (TW)

(72) Inventor: Wun-Da Yang, Tainan (TW)

(21) Appl. No.: 14/485,819

(22) Filed: Sep. 15, 2014

(30) Foreign Application Priority Data
Jan. 9, 2014 (TW) 103200451

(51) Int. Cl. B32B 5/18; B32B 15/04; B32B 27/10

(52) U.S. Cl. CPC B32B 5/18; B32B 27/10; B32B 15/046; B32B 2439/00; B32B 2307/304
USPC 428/34.3; 428/35.7; 428/35.8; 428/36.5

(57) ABSTRACT

A packaging structure of container is provided with a base layer and an insulating layer joined together to form a flexible packaging structure. The base layer can be made of paper materials or metal materials, and the insulating layer can be made of the foam thermal insulation materials of EPE, EPP, EPS, EPO, or materials with similar properties. The packaging structure provides packaging to wrap around items that can be packed, such as bottles or cans, and achieves the benefit of insulation and heat preservation using the insulating layer. In addition, a magnetic layer can be provided on the insulating layer, so that the packaging structure not only provides benefits of insulation and heat preservation through the package of various shapes of items, but also provides the effect of fixture by having its both ends absorbing each other at a fixed position using the magnetic layer afterward.

### BACKGROUND OF THE INVENTION

1. Field of the Invention

The invention relates to packaging containers and more particularly to a packaging structure that can achieve the function of insulation and heat preservation as well as the convenience of portability after being used to wrap the container.

2. Description of Related Art

When the general consumers purchase chilled or microwaved items from a store, either the store will provide plastic bags or the consumers will bring their own grocery bags to carry the purchased items home. Using either types of bags, the consumers usually find that the purchased items are no longer cold or hot, nor the freshness being preserved. Therefore, how to effectively preserve items at a specific temperature and what to provide so that the consumers can have a portable and easy to use packaging of container becomes a subject for the industry to consider.

Thus, the need for improvement still exists.

### SUMMARY OF THE INVENTION

An objective of the invention is to wrap the items that can be packaged, such as bottles and cans, by packaging in order to achieve the purpose of insulation and benefits of preserving the temperature of the wrapped item.

A second objective of the invention is to provide a package of good portability, allowing users to perform wrapping on items that can be packaged, including bottles and cans, by packaging at any time in any place in order to achieve the benefit of portability and implementation.

Based on the aforementioned objectives, the packaging structure of container of the invention comprises a base layer and an insulating layer jointed together to form a flexible packaging structure, wherein the base layer can be made of paper materials or metal materials such as iron or copper and the insulating layer can be made of the foam thermal insulation materials of EPE, EPP, EPS, EPO, or materials with similar properties and equivalent effects. The packaging structure can provide coating to wrap around items that can be packaged, such as bottles or cans, in order to achieve the goal of insulation and preserve the packaged item at a specific temperature using the insulating layer.

Another structure of the embodiment of the invention is to provide a magnetic layer on the insulating layer, wherein the magnetic layer can be a flexible soft magnet. Using the magnetic layer, both ends of the packaging structure can wrap around the item according to its shape, and can apply the magnetic property of both ends of the packaging structure to absorb to each other afterward.

The above and other objects, features and advantages of the invention will become apparent from the following detailed description taken with the accompanying drawings.

### BRIEF DESCRIPTION OF THE DRAWINGS

FIG. 1 is a perspective view of a packaging structure of container of a first preferred embodiment of the invention;

FIG. 2 is a sectional view of the packaging structure of container shaped as a cylinder;

FIG. 3 is a sectional view of the packaging structure of container with a container disposed therein;

FIG. 4 is a perspective view of a packaging structure of container of a second preferred embodiment of the invention;

FIG. 5 is a sectional view of the packaging structure of container of FIG. 4;

FIG. 6 is a view similar to FIG. 5 showing the packaging structure of container being folded to form a cylinder; and

FIG. 7 is a sectional view of the packaging structure of container with a container disposed therein.

### DETAILED DESCRIPTION OF THE INVENTION

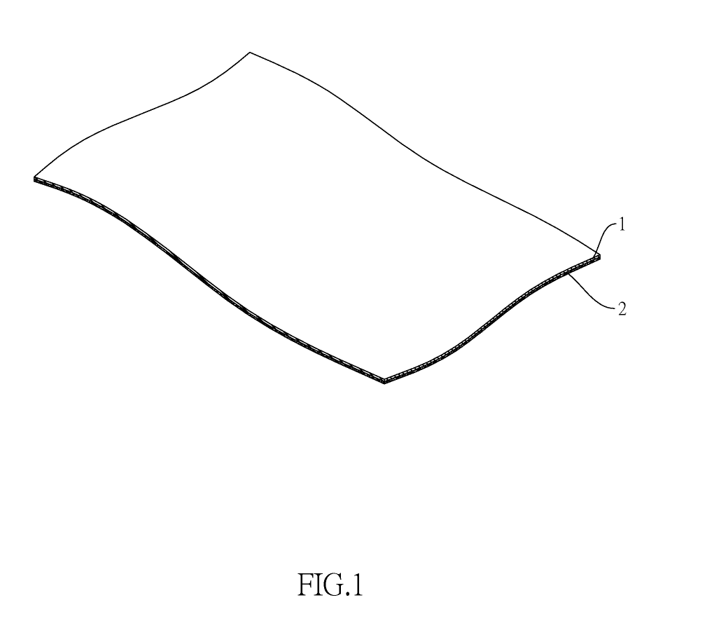

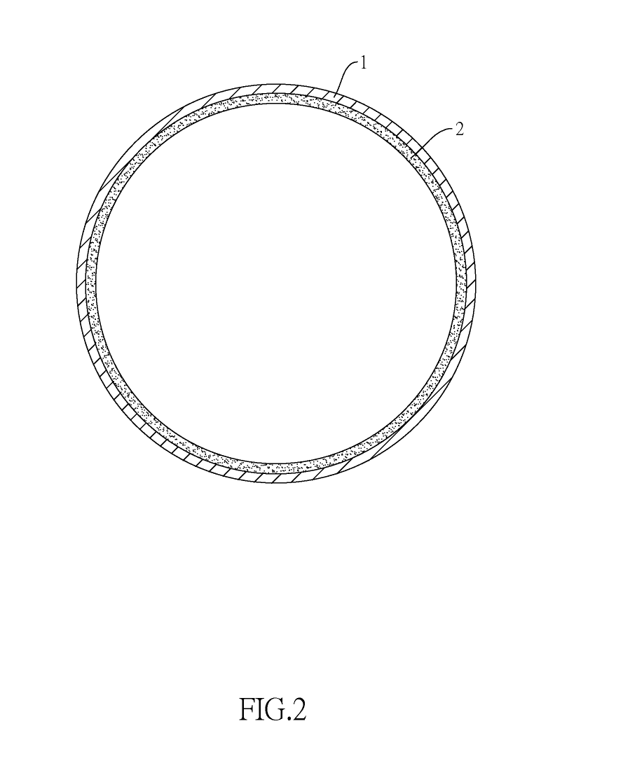

Referring to FIGS. 1 to 3, a packaging structure of container in accordance with a first preferred embodiment of the invention comprises a base layer 1 and an insulating layer 2 adhered to a top surface of the base layer 1 to form a flexible packaging structure. The base layer 1 can be made of paper materials or metal materials. The metal materials can be classified as iron or copper materials. The insulating layer 2 can be made of the foam thermal insulation materials of EPE, EPP, EPS, EPO, or materials with similar properties and equivalent effects. A simple composition of the base layer 1 and the insulating layer 2 forms a complete packaging structure of container and achieves the purpose of commercial mass production.

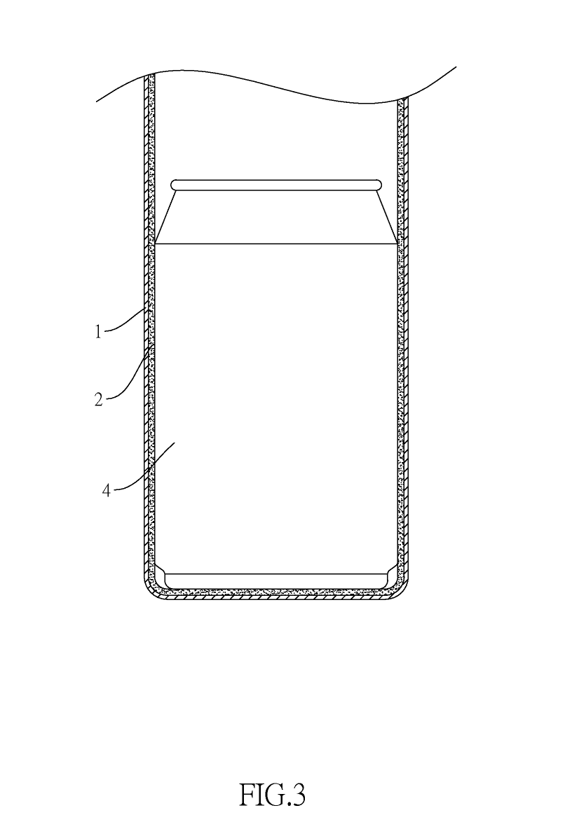

As shown in FIG. 3 specifically, in use a packaged item 4 that can be packed (e.g., a beverage can as shown) is disposed in the base layer 1 and the insulating layer 2. When the packaged item 4 is removed from the refrigerator or is heated to a specific temperature by an electric thermal warmer, if the user wants to maintaining temperature of fluids in the packaged item 4, the user can use the insulating layer 2 to wrap the packaged item 4 and apply the base layer 1 to prevent the packaged item 4 from outside impact in order to achieve the purpose of maintaining temperature of the fluids in the packaged item 4 through insulation as well as the benefit of protecting the container inside the package.

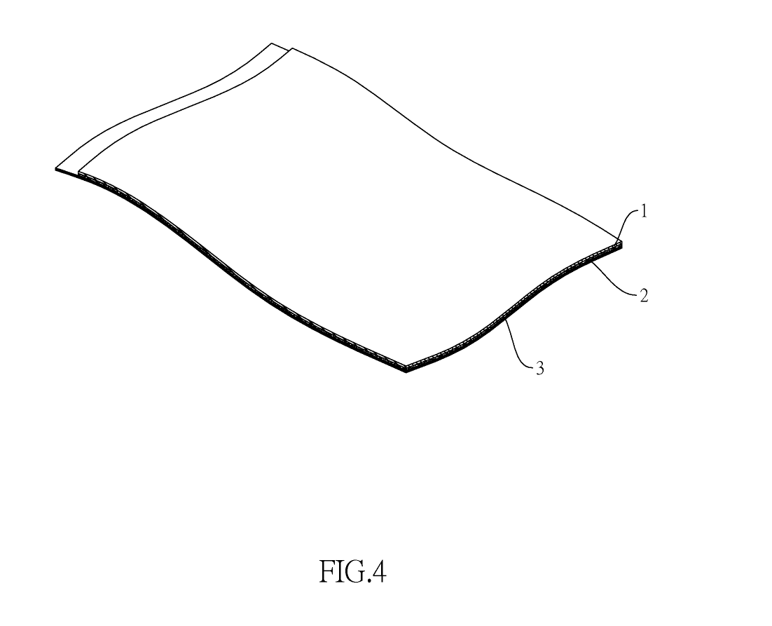

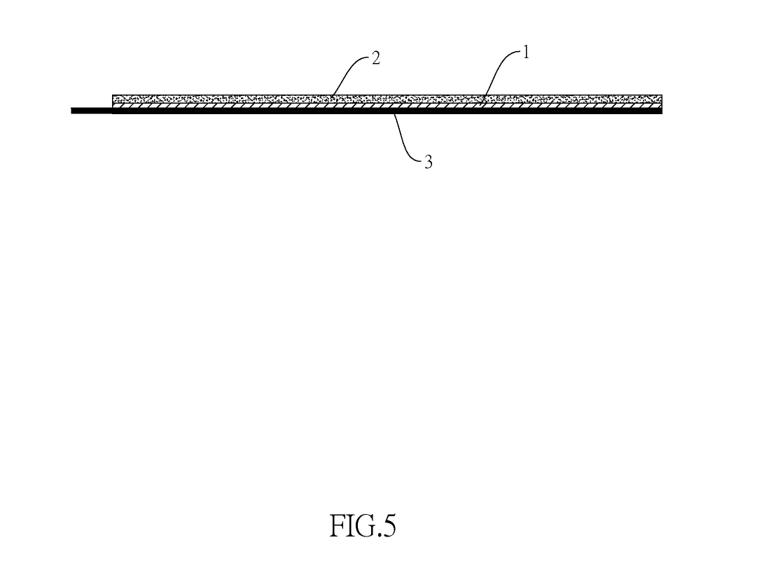

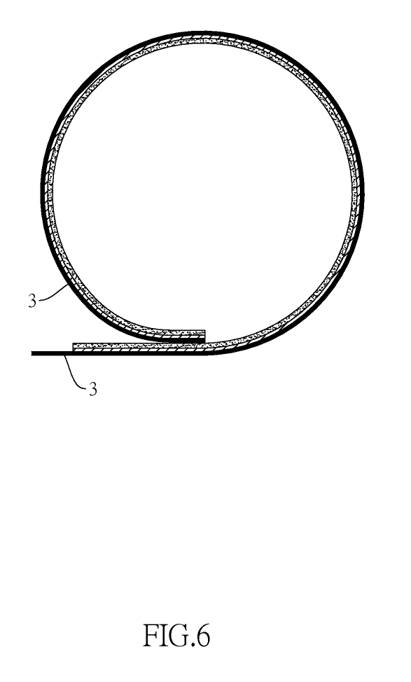

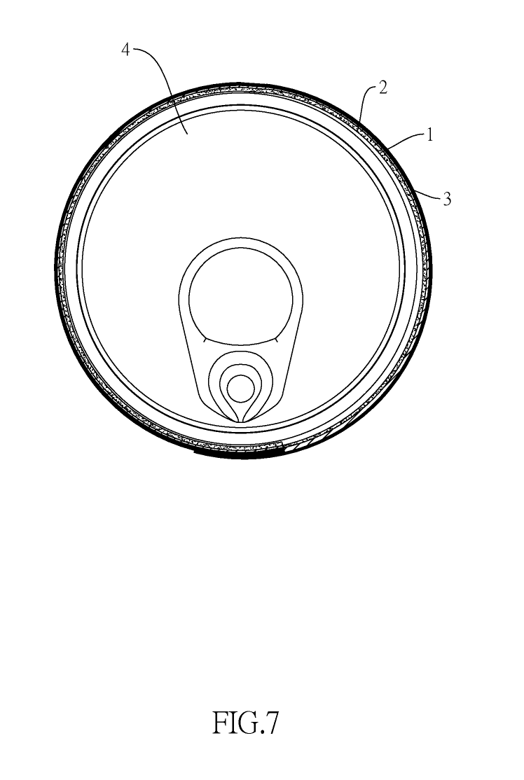

Referring to FIGS. 4 to 7, a packaging structure of container in accordance with a second preferred embodiment of the invention is shown. The characteristics of the second preferred embodiment are substantially the same as that of the first preferred embodiment except the following:

A magnetic layer 3 can be provided on a bottom surface of the base layer 1. The magnetic layer 3 is a flexible soft magnet. By applying the adsorbent properties of the magnetic layer 3, one end of the packaging structure can be curled in shape and absorbed to the other end (as shown in FIG. 4). Thus, when the user needs to package the merchandise, the user can apply wrapping according to the shape of the packaged item 4 and make the base layer 1 and the insulating layer 2 to attach to the packaged item 4 closely. In addition, the insulating layer 2 is used to achieve the goal of insulation and the base layer 1 prevents the packaged item 4 from outside impact. The provision of the base layer 1, the insulating layer 2, and the magnetic layer 3 is a simple packaging structure as a convenient, portable packaging structure of container.

In view of aforementioned description, the packaging structure of container of the invention has the following advantages:

Using the base layer and the insulating layer to form a simple composition as a complete packaging structure of container in order to achieve the goal of mass production.

Using the insulating layer to maintain temperature and the base layer to protect the packaged item from outside impact in order to achieve the purpose of maintaining temperature through the insulation as well as the benefit of protection the item inside the package.

Using the mutually absorbent properties of the magnetic layer, one end of the packaging structure can be curled in shape and absorbed to the other end, and when the user needs to package the merchandise, the packaging structure can be used to achieve the purpose of packaging according to the shape of the item.

While the invention has been described in terms of preferred embodiments, those skilled in the art will recognize that the invention can be practiced with modifications within the spirit and scope of the appended claims.

What is claimed is:

1. A packaging structure of container, comprising:
a base layer; and
an insulating layer adhered to a top surface of the base layer to form a flexible packaging structure in order to package various shapes of items.

2. The packaging structure of container as claimed in claim 1, wherein the insulating layer is made of foam thermal insulation materials.

3. The packaging structure of container as claimed in claim 2, wherein the foam thermal insulation material is EPE, EPP, EPS or EPO material.

4. The packaging structure of container as claimed in claim 1, wherein the base layer can be made of paper materials.

5. The packaging structure of container as claimed in claim 1, wherein the base layer can be made of metal materials.

6. The packaging structure of container as claimed in claim 5, wherein the metal materials can be iron or copper materials.

7. A packaging structure of container, comprising:
a base layer;
an insulating layer adhered to a top surface of the base layer; and
a magnetic layer adhered to a bottom surface of the base layer to form a flexible packaging structure in order to package various shapes of items and to use the magnetic layer to make both ends of the packaging structure to mutually absorb and fix to each other.

8. The packaging structure of container as claimed in claim 7, wherein the magnetic layer can be a flexible soft magnet.

9. The packaging structure of container as claimed in claim 7, wherein the insulating layer is made of foam thermal insulation materials.

10. The packaging structure of container as claimed in claim 9, wherein the foam thermal insulation material is EPE, EPP, EPS or EPO material.

11. The packaging structure of container as claimed in claim 7, wherein the base layer can be made of paper materials.

12. The packaging structure of container as claimed in claim 7, wherein the base layer can be made of metal materials.

13. The packaging structure of container as claimed in claim 12, wherein the metal materials can be iron or copper materials.
